(19) United States
(12) Patent Application Publication
(10) Pub. No.: US 2018/0308101 A1
(43) Pub. Date: Oct. 25, 2018

(54) A SYSTEM FOR PROXIMATE AND/OR REMOTE ELECTRONIC TRANSACTION AUTHORIZATION BASED ON USER AUTHENTICATION AND/OR BIOMETRIC IDENTIFICATION

(71) Applicant: Renato Valencia, Muntinlupa City, Metro Manila (PH)

(72) Inventor: Renato Valencia, Muntinlupa City, Metro Manila (PH)

(21) Appl. No.: 15/509,386

(22) PCT Filed: May 6, 2016
(86) PCT No.: PCT/IB2016/052586

§ 371 Date: Mar. 7, 2017

(30) Foreign Application Priority Data
Jan. 13, 2016 (PH) PH22016000048

(51) Int. Cl. G06Q 20/40; G06K 19/077; G06F 21/32

(52) U.S. Cl. CPC G06Q 20/40145; G06F 21/32; G06K 19/07739

(57) ABSTRACT

An information capturing and transaction device may be used to capture a user's biometric information which in turn may be received by a secure element such as a SIM card. SIM card-based captured biometric keys are generated based on the user's biometric information and compared with SIM card-based reference biometric keys. If these two SIM card-based keys match with one another, access to each of a plurality of applications residing on the SIM card may be permitted. The applications may be selectively activatable from the SIM card. The applications, which may include payment and voting applications, may be executed and operated from the SIM card to perform an electronic transaction on a third-party computer system such as an electronic payment system and electronic voting system.

### CROSS-REFERENCE TO RELATED APPLICATIONS

NONE

### FEDERALLY SPONSORED RESEARCH

NOT APPLICABLE

### SEQUENCE LISTING OR PROGRAM

NOT APPLICABLE

### TECHNICAL FIELD

The present invention relates in general to computer-based, computer-implemented and/or computer-assisted system for authorizing electronic transactions. More specifically, an implementation of the present invention provides such a system for authorizing an electronic transaction which may be based on user authentication and/or biometric identification.

### BACKGROUND ART

Through the years, electronic transactions in various service networks such as financial service networks and customer service networks are susceptible to fraudulent and dishonest practices. Consequently, user authentication technologies have been developed to improve the security of these transactions. Knowledge-based authentication and possession-based authentication technologies have been introduced in the age of information technology in an attempt to improve security in such financial and customer service networks and user authentication systems with fidelity and integrity verification.

The knowledge-based authentication technologies commonly require knowledge of a password or a PIN (personal identification number) code in order for any interested user to gain access to a system of electronic devices or computers. The possession-based authentication technologies, on the other hand, require actual possession of an identification card in order for any interested user to gain access to such system of electronic devices or computers. These technologies, separately or in combination with one another, have been widely implemented and accepted. Through these technologies, identification of authorized individual users accessing a system of electronic devices or computers is believed to have at least minimized fraudulent and dishonest practices surrounding electronic transactions in various service networks.

However, most knowledge-based authentication and possession-based authentication technologies are not reliable at all times. Knowledge of a personal password, in one instance, is unreliable because such password may still be stolen through password hacking attacks or may be forgotten by human users due to various reasons which may include influx of new knowledge, experience, and skills. Actual possession of an identification card, in another instance, is also unreliable because such card may be misplaced, stolen or damaged due to wear-and-tear brought about by its common degree of exposure to the external environment and prolonged and rough usage. Simply put, use of passwords and identification cards renders each of the knowledge-based and possession-based authentication technologies unreliable and problematic.

In light of these and such other threats in the security of electronic transactions emerging in the afore-described knowledge-based authentication and possession-based authentication technologies, unauthorized access to a system of electronic devices or computers by unauthorized users presents operational difficulties and cost-bearing problems such as identity theft through misappropriation of personal and confidential information and as well as threats to property or personal security. Electronic transactions with improved access control and which do not merely rely on hackable passwords and environmentally-exposed identification cards are, therefore, highly desirable.

### SUMMARY OF THE INVENTION

One aspect of the invention can include a system for authorizing an electronic transaction based on user authentication and biometric identification. An information capturing and transaction device may be used to capture a user's biometric information which in turn may be received by a secure element such as a SIM card. SIM card-based captured biometric keys are generated based on the user's biometric information and compared with SIM card-based reference biometric keys. If these two SIM card-based keys match with one another, access to each of a plurality of applications residing on the SIM card may be permitted. The applications may be selectively activatable from the SIM card. The applications, which may include payment, voting, ID, access to facilities, license, passport and other applications in accordance with some preferred implementations of the invention, may be executed and operated from the SIM card to perform an electronic transaction on a third-party computer system such as an electronic payment, voting or any other system.

Preferably, server-based reference biometric keys are pre-stored on the third-party computer system. Performance of the transaction on the third-party computer system by the user may require comparison of the SIM card-based reference biometric keys with the server-based reference biometric keys. Matching reference keys based on this comparison may permit the user to perform the transaction. The biometric identification and authentication, either on the SIM card side or on the third-party computer system side, may be implemented if a configuration of the third-party computer system requires its use. Otherwise, or in the event of technical failure associated with the use of the biometric identification and authentication, PIN (personal identification number) codes or identity information embedded in identification cards and/or the SIM card may still be used or serve as a secondary level of backup for authentication.

The provision of the biometric identification and authentication on the SIM card, which has stronger and more reliable security features as compared with phones and other devices, ensures that the identity information of the user cannot be stolen by hacking attacks. In addition, the biometric information is generally known to be unique for every human user. Further, the normal wear-and-tear of the SIM card storing the biometric keys generated from the biometric information of the user and from which applications can be executed and operated for performing a variety of electronic transactions is significantly decelerated since, inside the information capturing and transaction device, the SIM card can stay protected against the external environment and its regular, prolonged or potentially rough usage by the user.

### BRIEF DESCRIPTION OF THE DRAWINGS

FIG. 1 is a block diagram illustrating a system for authorizing an electronic transaction in accordance with one or more preferred implementations of the invention.

FIG. 2 is a schematic block diagram illustrating an exemplary architecture of an information capturing and transaction device suitable for use in the system of FIG. 1.

FIG. 3 is a schematic block diagram illustrating an exemplary architecture of a secure element suitable for use in the system of FIG. 1.

### DETAILED DESCRIPTION OF PREFERRED IMPLEMENTATIONS

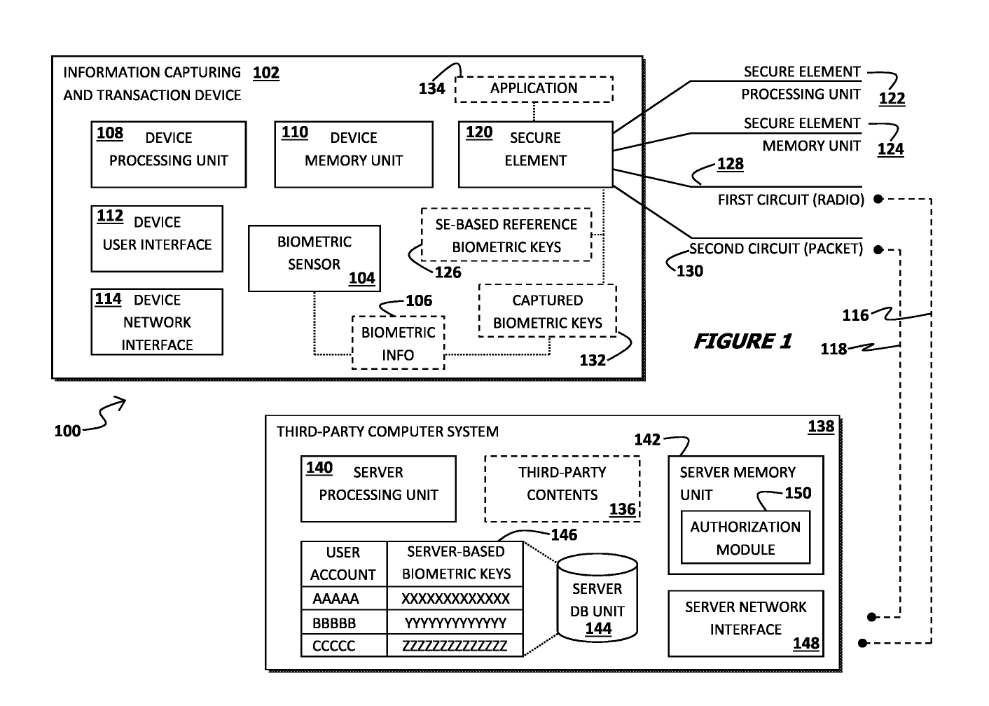

Referring to FIG. 1, there is shown a block diagram illustrating a system for authorizing an electronic transaction in accordance with one or more preferred implementations of the present invention. The present invention is mainly directed to this system, which is consistently designated by reference numeral 100, for proximate and/or remote electronic transaction authorization which may be based on user authentication and/or biometric identification.

All the ensuing disclosures and illustrations of the preferred implementations of the system 100 for authorizing an electronic transaction of the present invention are merely representative for the purpose of sufficiently describing the manner by which the present invention may be carried out into practice in various ways other than the ones outlined in the ensuing description.

It is to be understood and appreciated by a person skilled in the art or having ordinary skills in the art, however, that the exemplary implementations used to describe how to make and use the present invention may be embodied in many alternative forms and should not be construed as limiting the scope of the appended claims in any manner, absent express recitation of those features in the appended claims. All the diagrams accompanying the ensuing description should also not be construed as limiting the scope of the appended claims in any manner.

It is also to be understood and appreciated that the use of ordinal terms such as “first” and “second” is used herein to distinguish from one element, feature, component, calculation or step from another and should not also be construed as limiting the scope of the appended claims, and that these and such other ordinal terms that may appear in the ensuing description are not indicative of any particular order of elements, features, calculations, components or steps to which they are attached. For example, a first element could be termed a second element. Similarly, a second element could be termed a first element. All these do not depart from the scope of the herein disclosure and its accompanying claims.

Unless the context clearly and explicitly indicates otherwise, it is to be understood that like numbers refer to like elements throughout the ensuing description of the figures, that the linking term “and/or” includes any and all combinations of one or more of the associated listed items, that the singular terms “a”, “an” and “the” are intended to also include the plural forms, and that some varying terms of the same meaning and objective may be interchangeably used.

In one preferred implementation, the system 100 is computer-assisted, computer-based and/or computer-implemented, and the system 100 mainly comprises an information capturing and transaction device 102 and a secure element 120 in electrical and electronic communication with one another. The information capturing and transaction device 102 captures, through a biometric sensor 104, biometric information 106 of at least one body feature associated with a human user. The information capturing and transaction device 102, in effect, receives the biometric information 106 from the user through the biometric sensor 104.

The information capturing and transaction device 102 includes a device processing unit 108, a device memory unit 110 in communication with the device processing unit 108, a device user interface 112 in communication with the device processing unit 108, and a device network interface 114 in communication with the device processing unit 108 and for interfacing the information capturing and transaction device 102 with any of a first communication network 116 and a second communication network 118, enabling the information capturing and transaction device 102 to communicate with any other computer systems or any other electronic devices connected to any of the first and second communication networks 116, 118.

The secure element 120, which is in operative communication with the information capturing and transaction device 102, includes a secure element processing unit 122 and a secure element memory unit 124 in communication with the secure element processing unit 122. The secure element memory unit 124 is capable of storing at least one set of secure element-based reference biometric keys 126 associated with the user. The secure element memory unit 124 is a computer-readable medium which may be a flash memory or other non-volatile type of memory known in the art of computing and which may be capable of storing other data apart from the secure element-based reference biometric keys 126.

The secure element 120 may include a first circuitry 128 operable to communicate with the first communication network 116. The first communication network 116 may operate in accordance with a first set of communication standards and protocols which enables radio data communication. The secure element 120 may also include a second circuitry 130 operable to communicate with the second communication network 118. The second communication network 118 may operate in accordance with a second set of communication standards and protocols which enables packet data communication.

The secure element processing unit 122 of the secure element 120 is configured to be capable of receiving the captured biometric information 106 from the information capturing and transaction device 102. The secure element processing unit 122 is also configured to be capable of processing the captured biometric information 106 to derive at least one set of secure element-based captured biometric keys 132, and of permitting an access to at least one application 134 residing on the secure element 120 based on a comparison of the set of secure element-based captured biometric keys 132 with the set of secure element-based reference biometric keys 126.

Requiring use of the comparison between the set of secure element-based captured biometric keys 132 and the set of secure element-based reference biometric keys 126 may depend on a configuration of the application 134. It is to be understood and appreciated that the application 134 may be configured to use the biometric identification and/or authentication of the system 100 of the present invention, any knowledge-based authentication technologies, any possession-based authentication technologies, or any one or more suitable combinations thereof. The secure element 120 may embody a SIM (subscriber identification module or subscriber identity module) card of the type comprising a laminated body of plastic material.

The application 134 is preferably executable and operable by the user from the SIM card 120 through the device user interface 112 of the information capturing and transaction device 102 to access third-party contents 136 residing on a third-party computer system 138 via any of the first communication network 116 and the second communication network 118 depending on a configuration of the third-party computer system 138. The application 134 may include a set of routines, a set of functions, a set of modules, a set of scripts, a set of processes, or the like, each of which may be composed using any suitable programming language such as C, C++, Java, Javascript, C#, Perl, and the like.

The third-party computer system 138 preferably includes a server processing unit 140, a server memory unit 142 in communication with the server processing unit 140, a server database unit 144 associated with the server processing unit 140 and having pre-stored thereon a plurality of sets of server-based reference biometric keys 146, and a server network interface 148 in communication with the server processing unit 140 and for interfacing the third-party computer system 138 with any of the first and second communication networks 116, 118. The plurality of sets of server-based reference biometric keys 146 may belong to several user accounts registered on the server database unit 144 of the third-party computer system 138.

The third-party computer system 138 may further include an authorization module 150 executable by the server processing unit 140 from the server memory unit 142 for authorizing any given user account associated with the user to be used for performing at least one electronic transaction on the third-party computer system 138 based on a comparison of the set of secure element-based reference biometric keys 126 with each set of server-based reference biometric keys 146 of the plurality of sets of server-based reference biometric keys 146 and depending on the configuration of the third-party computer system 138.

It is to be understood and appreciated that the authorization module 150 may not use biometric authentication if the configuration of the third-party computer system 138 does not require the same biometric authentication. Instead, in the absence of such biometric authentication, the third-party computer system 138 may be configured to use other forms of identification and/or authentication such as PIN (personal identification number) codes, digital signatures, SMS (short messaging service) based OTP (one-time password), electronic mail based OTP, client certificate, and token-based authentication systems which may reside in the secure element 120 or on the device memory unit 110 of the information capturing and transaction device 102. The third-party computer system 138 may also use any one or more of these authentications systems in combination with the biometric identification and other authentications of the system 100 of the present invention.

It is to be understood and appreciated that the illustrated authorization module 150 of the system 100 for authorizing an electronic transaction of the present invention may or may not correspond to discrete blocks of software codes, depending on how specific functions are configured to be performed by the authorization module 150. In this regard, it can be readily realized that the electronic transaction authorization function described for the authorization module 150 can be performed by executing various code portions which are stored on the server memory unit 142 of the third-party computer system 138.

The information capturing and transaction device 102 may be any one of a desktop computer, a laptop computer, a tablet personal computer, a smart-phone, a mobile telephone, a cellular phone, a personal digital assistant (PDA), a netbook computer, a notebook computer, a vehicle-mounted computer, a wearable device, a hybrid tablet-laptop, a digital camera, and a media player. The information capturing and transaction device 102 may be any handheld electronic device capable of communicating with other electronic devices, computers, or systems of computers over any of the first and second communication networks 116, 118.

Each of the abovementioned types of the information capturing and transaction device 102 is preferably capable of receiving from the user the biometric information 106 of the body feature associated with the same user either in an image format, an audio format, a video format, or any suitable combination of the image, audio and video formats. Each of the abovementioned types of the information capturing and transaction device 102 is further capable of electrically and electronically communicating with the secure element 120.

The biometric information 106 can be captured using multi-modal biometric identification or sensing mechanisms associated with the information capturing and transaction device 102, e.g., using the biometric sensor 104. These multi-modal biometric identification or sensing mechanisms may involve use of camera, microphone, or other devices of the same nature or general characteristics. The biometric sensor 104 may include, by way of example and not by way of limitation, face sensors for facial attribute recognition, speech sensors for speech recognition, optical measurement based sensors for iris pattern recognition, corneal pattern recognition and retinal scan, and as well as fingerprint sensors for fingerprint scan.

The biometric sensor 104 may also include palm sensors for palm vein pattern recognition, hand sensors for hand geometry recognition, and handwriting sensors for signature recognition. It is to be understood and appreciated that biometric measurements of any of other body features of the user may also be utilized in the system 100 for authorizing an electronic transaction of the present invention. The biometric information 106 captured by these and such other related sensors 104 may correspond to the identifying characteristics of the individual human users. Put differently, these characteristics can be utilized to identify, verify and/or authenticate identity and/or personal information of individual human users. Any one or suitable combinations of the aforementioned biometric information 106 and/or the captured biometric keys 132 are preferably transmitted from the information capturing and transaction device 102 to the secure element 120 which is in operative communication with the information capturing and transaction device 102 through appropriate circuit connection.

It is to be understood and appreciated that the secure element 120 can be inserted to and/or installed in the information capturing and transaction device 102 in a fixed or detachable manner, and that the secure element 120 may be arranged to utilize the computing resources (e.g., the device processing unit 108 and the device memory unit 110) of the information capturing and transaction device 102 in executing computer-executable instructions or software applications since most secure elements known in the art of electronics and communications, which include the secure element 120, commonly have limited computing resources and are devoid of multi-tasking capabilities.

The secure element 120 may be installed in a dedicated area of the information capturing and transaction device 102 and may be implemented as a Universal Integrated Circuit Card (UICC), an embedded Secure Element (eSE) card, a smart Secure Digital card, a smart micro Secure Digital card, or a SIM (subscriber identity module or subscriber identification module) card.

It is preferable that the secure element 120 is implemented as a tamper-resistant integrated circuit pre-installed with the application 134 which can be executed and operated by the user through the device user interface 112 of the information capturing and transaction device 102. Further, it is preferable that multiple smart card-grade applications, collectively embodied by the application 134, are installed in the secure element 120 and can be operated to provide prescribed functionalities in a secure fashion.

By executing and operating the application 134, the user, who may be a customer user, is provided with means to access the third-party contents 136 residing on the third-party computer system 138. The access to and/or manipulation of the third-party contents 136 may be characterized by performance of an electronic transaction.

The electronic transaction may be a payment or value exchange transaction which may embody, by way of example and not by way of limitation, a cash card-based transaction, a credit card-based transaction, a debit card-based transaction, a check-based transaction, a prepaid card-based transaction, a loyalty card-based transaction, a mileage earning-based transaction, and a gift check-based transaction. Generally, the identity of the customer user can be authenticated, verified and/or authorized to enable the customer user to perform any one or more of these payment or value exchange transactions.

The electronic transaction may also be an access control transaction which may embody, by way of example and not by way of limitation, electronic transactions relating to access to physical locations such as building facilities, vehicles, local computers, remote computers, and server computers, access to point-of-sale devices, access to electronic equipment and machines, access to various facilities such as health facilities, library facilities, recreational facilities, research facilities, government or federal facilities, sports and leisure facilities, training facilities, bank facilities, university facilities, shore-based welfare facilities, and maritime facilities.

The access control transaction may also be any one or more of access to information technology facilities, private facilities, public facilities and the like, access to health records, medical records, personal records and the like, access to public and/or private services like social security services, club membership services, and clearance issuing services, access to toll road usage services, access to parking area usage services, and access to diplomatic and international channels through the use of passport, visa and/or other border crossing and travel requirements. Generally, the identity of an accessing user can be authenticated, verified and/or authorized to enable the accessing user to perform any one or more of these access control transactions.

The electronic transaction may also involve booking, reservation, ticket, boarding pass, payment and/or fulfillment relating to such user activities, which may embody, by way of example and not by way of limitation, land-based, air-based, sea-based and/or space-based travel, theatres, cinemas, events, live performances, entertainment, parties, meetings, conferences, seminars, workshops, corporate events, conventions, tradeshows, sporting occasions, cultural occasions, and wedding receptions. Generally, the identity of an interested user can be authenticated, verified and/or authorized to enable the interested user to perform any one or more of these booking, reservation, ticket, boarding pass, payment and/or fulfillment transactions.

The electronic transaction may also be a permit verification transaction which may embody, by way of example and not by way of limitation, permit verifications associated with driver's licenses, fishing licenses/permits, hunting licenses/permits, gun carrying licenses/permits or concealed handgun licenses/permits, weapon ownership licenses/permits, explosive manufacturing and/or distribution licenses/permits, mining licenses/permits, and other recreational activity licenses/permits.

The electronic transaction may also be a decision-based transaction which may embody, by way of example and not by way of limitation, decisions associated with voting in an electoral event, polling in a survey administration, opinion gathering in a marketing or promotion event, betting in a gaming, wagering, lottery, racing or gambling event, quizzing in a quiz type competition event, and the like. Generally, the identity of a deciding user can be authenticated, verified and/or authorized to enable the deciding user to perform any one or more of these permit verification transactions.

In one exemplary implementation of the present invention, the configuration of the third-party computer system 138 may be such that it communicates with the secure element 120 which provides a payment application for enabling performance of a payment or value-exchange transaction, which can be embodied by the application 134, associated with a credit card based transaction on a POS (point of sale) terminal equipped with NFC (near-field communication) enabled reading device and access to such third-party computer system 138 is hence supported by radio data communication. NFC may be based on existing radio-frequency identification (RFID) standards.

The payment application 134 may be used by a purchasing user to manipulate the third-party contents 136 and perform the payment or value-exchange transaction on the third-party computer system 138 on which the third-party contents 136 may reside. In that case, the first circuitry 128 of the secure element 120 can be caused to communicate with the first communication network 116 operating in accordance with the first set of communication standards and protocols which enables the radio data communication in order to electronically effect crediting a financial value, though the third-party computer system 138 interfacing with the payment application 134 for the performance of the payment and value-exchange transaction, to a biometrically-authenticated, verified and/or authorized financial account associated with the purchasing user of the information capturing and transaction device 102 in which the secure element 120 is operably installed.

The first set of communication standards and protocols enables proximate exchange of financial data between the information capturing and transaction device 102 in which the secure element 120 is operably installed and the third-party computer system 138 using an appropriate radio frequency credential or plurality of radio frequency credentials, and may include, by way of example and not by way of limitation, the aforementioned NFC, Bluetooth, low frequency RFID (radio frequency identification), high frequency RFID, and ultra high frequency RFID having different capabilities and read range, generally from centimetres (short range) to about a meter (medium range).

Other short-range wireless protocols that may characterize the first communication network 116 may include, by way of example and not by way of limitation, Wi-Fi (IEEE 802.11) which is a communication technology that uses radio waves to provide wireless Internet and network connections, DSRC (dedicated short range communications) which operates on radio frequencies for vehicle-to-vehicle or vehicle-to-infrastructure communications, and ZigBee (IEEE 802.15.4) which is a communication technology that uses low-power digital radio signals to provide connections in personal area networks.

In the given example of the third-party computer system 138 being characterized by an electronic payment system, an issuer computer system of a Telco or telecommunications company may have cooperation with a co-issuer computer system of a credit card issuer which may be a financial institution, wherein the co-issuer computer system may constitute or may be part of the electronic payment system embodied by the third-party computer system 138.

The Telco may act as the issuer of the secure element 120 which is preferably in the form of the aforementioned SIM card 120. All SIM card-related information may be stored on the issuer computer system of the Telco while all credit card-related information may be stored on the co-issuer computer system of the financial institution. The SIM card-related information and the credit card-related information may also be shared by and between the issuer and the co-issuer computer systems of the Telco and the financial institution, respectively.

The cooperation between the issuer computer system of the Telco and the co-issuer computer of the financial institution may be such that a plurality of applications embodied by, or collectively included in, the application 134 can be stored on and made executable from the SIM card 120 using the computer system of the Telco. The general nature of these applications 134 depends on what is required by or on the preferences of the financial institution. For example, payment applications such as electronic passbook applications, electronic checkbook applications, electronic wallet applications, electronic cash card applications, and electronic credit card applications may constitute the applications 134 that can be embedded on the SIM card 120 using appropriate programming tools.

Once the specific payment applications 134 have been assigned to the financial institution depending on the preference of the financial institution and consequently arranged on the SIM card 120 using the issuer computer system of the Telco, the SIM card 120 embedded with the payment applications 134 may be issued to the purchasing user.

These financial institution preferred payment applications 134 may be arranged to be executable and operable by the user from the SIM card 120. The purchasing user, upon inserting and activating the SIM card 120 in a mobile phone, may selectively activate any one or more of the payment applications 134 embodied by the plurality of applications 134 of his choosing either in a direct (e.g., personal appearance) or remote manner (e.g., through the Internet). The mobile phone may be embodied by the information capturing and transaction device 102.

Directly, the purchasing user may physically visit the financial institution whereby the purchasing user may submit to a representative of the financial institution a request for activation of each payment application 134 of his or her interest. For example, the purchasing user may request for activation of the aforementioned electronic passbook application 134 and electronic credit card application 134. Subject to the request made by the user, the co-issuer computer system may be used by the financial institution's representative to activate the electronic passbook application 134 and the electronic credit card application 134 in the SIM card 120. The activation of the electronic passbook and electronic credit card applications 134 may be made to associate the same applications 134 with a passbook account and a credit card account, respectively, of the purchasing user with the financial institution.

Remotely, the purchasing user may visit a website of the financial institution whereby the user may electronically request for activation of each of his or her preferred payment applications 134 residing on the SIM card 120. For example, the purchasing user may remotely request for activation of the aforementioned electronic passbook application 134 and electronic credit card application 134 over any appropriate communication network such as the Internet. In response to this request, the co-issuer computer system of the financial institution may be configured to activate the electronic passbook application 134 and the electronic credit card application 134 in the SIM card 120.

The activation of the electronic passbook and credit card applications 134 may be made to associate the same applications 134 with the passbook and credit accounts, respectively, of the purchasing user with the financial institution.

In any of the direct or remote scenario, the biometric information 106 of the purchasing user may be captured using either the mobile phone 102 of the purchasing user or the co-issuer computer system of the financial institution. Subsequently, SIM card-based reference biometric keys 126 may be generated based on the biometric information 106 of the purchasing user. The biometric keys 126 associated with the purchasing user can be stored on the SIM card 120 issued to the purchasing user and on the co-issuer computer system of the financial institution for authentication, verification and/or authentication on demand, anytime, and anywhere.

If the biometric information 106 is captured by the mobile phone 102 of the purchasing user, then the SIM card 120 generates the SIM card-based reference biometric keys 126 and transmits the same to the co-issuer computer system of the financial institution through any suitable communication network or communication link. In the co-issuer computer system of the financial institution, the SIM card-based reference biometric keys 126 become the server-based reference biometric keys 146, and the two biometric keys 126, 146 therefore match with one another or are completely identical.

Otherwise, if the biometric information 106 is captured by the co-issuer computer system of the financial institution, then the co-issuer computer system generates the server-based reference biometric keys 146 and transmits the same to the SIM card 120 installed in the mobile phone 102 of the user over any suitable communication network or communication link. In the SIM card 120 issued to the purchasing user, the server-based reference biometric keys 146 become the SIM card-based reference biometric keys 126, and the two biometric keys 146, 126 therefore match with one another or are completely identical.

Alternatively, the Telco may issue the purchasing user the SIM card 120 from which the financial institution preferred payment applications 134 enabling performance of the payment and value exchange transactions can be operated and in which SIM card-based reference biometric keys 126 corresponding to his personal biometric information 106 can be stored and subsequently used for real-time or near real-time authentication, verification and/or authorization purposes.

At any point the purchasing user is ready to make payment at the checkout counter or the POS terminal of a grocery store in one instance, he or she may simply cause execution of any of the electronic credit card application 134 residing on the SIM card 120 installed in mobile phone 102. Access to the electronic credit card application 134 preferably requires biometric information 106 of the purchasing user. An appropriate sensor, such as the biometric sensor 104, of the mobile phone 102 may capture the biometric information 106 associated with the purchasing user. The SIM card 120 receives the captured biometric information 106, converts the captured biometric information 106 into SIM card-based captured biometric keys 132, and then compares the SIM card-based captured biometric keys 132 with the SIM card-based reference biometric keys 126.

The conversion of the captured biometric information 106 into the SIM card-based captured biometric keys 132 may be implemented using any conventional methodologies and techniques for extraction of local and global features such as minutiae, singularity points, and estimation of orientation and frequency of ridge regions of an electronic image associated with the biometric information 106 of individual human users. The biometric information 106 may also be converted into a cryptographic key for use in encryption and/or decryption purposes.

If the SIM card-based captured biometric keys 132 match with the SIM card-based reference biometric keys 126 at the time of initiation of the payment transaction by the purchasing user, then the purchasing user is provided with access to the electronic credit card application 134 residing on the SIM card 120 and in turn to the third-party contents 136 residing on the electronic payment system which is embodied by the third-party computer system 138 and which is interfaced with the electronic credit card application 134 residing on the SIM card 120. Otherwise, access to the electronic credit card application 134 residing on the SIM card 120 is denied or rejected thereby ensuring that no one else but the authorized purchasing user is permitted to use the electronic credit card application 134 and proximately access the third-party contents 136 of the electronic payment system 138.

The payment-related information like the credit card details (e.g., name of the purchasing user, billing address, and expiration date of the credit card) of the purchasing user may be pre-stored on or gathered at the time of transaction using the electronic credit card application 134. These payment-related information pre-stored or gathered using the electronic credit card application 134 may form part of the third-party contents 136 that can be provided to and/or processed by the electronic payment system 138.

The provision of exchange of any payment-related data between the mobile phone 102 and the electronic payment system 138 may be conducted over the first communication network 116 since the electronic payment system 138 is enabled for radio data communication. Once the purchasing user has provided or activated his credit card details and is ready to effect the payment, he can place his mobile phone 102 near the NFC enabled reading device associated with the POS terminal. At that moment, the SIM card 120 may be triggered to communicate with the first communication network 116 in order to transmit to, or verify with, the electronic payment system 138 the credit card details (or the “payment data” or the “payment information”).

A payment authorization module embodied by the authorization module 150 resides on the electronic payment system 138, and it is arranged suitable for use in authorizing the financial account associated with the purchasing user to be used for performing an electronic payment transaction on the electronic payment system 138 based on a comparison of the secure element-based reference biometric keys 126 with the server-based reference biometric keys 146 pre-stored or pre-registered on the payment server database unit 144 residing on the electronic payment system 138.

The financial account or user account is permitted to effect the electronic payment transaction by way of submission of, or verification of, the credit card details if and only if the secure element-based reference biometric keys 126 that the electronic payment system 138 receives from the mobile phone 102 match with any of the server-based reference biometric keys 146 residing on the electronic payment system 138. A matching set of reference biometric keys 126, 146 means that the financial account is authorized to perform the electronic payment transaction. Settlement of the payment effected by the purchasing user through the system 100 of the present invention may be made in accordance with conventional payment settlement methods and architectures.

It should be understood and appreciated that incidents of technical failures or errors within the system 100 for authorizing electronic transaction of the present invention may take place under different circumstances and may consequently render use of the biometric information 106 together with the biometric keys 126, 146 ineffective. In cases like this, PIN (personal identification number) codes or identification (ID) information embedded in identification cards and/or the SIM card 120, or security questions in some occasions, may still be used or serve as a secondary level of backup for authentication, verification and/or authorization. These PIN codes, ID information and security question information may also reside on the SIM card 120 and may be retrieved for authentication purposes through the application or applications 134 embedded on the SIM card 120.

In another exemplary implementation of the present invention, the configuration of the third-party computer system 138 may provide an application for enabling performance of the decision-based transaction, which is embodied by the application 134, associated with electoral voting and access to such third-party computer system 138 is supported by packet data communication (e.g., through the Internet). In that case, the second circuitry 130 of the secure element 120 can be caused to communicate with the second communication network 118.

The second communication network 118 may operate in accordance with the second set of communication standards and protocols enabling the packet data communication in order to electronically effect casting, in the third-party computer system 138 in communication with the application for the performance of the decision-based transaction associated with voting or “voting application” 134, of a vote of a biometrically-authenticated, verified and authorized voting account or user account associated with the voting user of the information capturing and transaction device 102 in which the secure element 120 is operably installed.

The second set of communication standards and protocols enables remote exchange of voting data between the information capturing and transaction device 102 in which the secure element 120 is operably installed and the third-party computer system 138.

The second set of communication standards and protocols may include, by way of example and not by way of limitation, network protocols such as IP (Internet Protocol), transport protocols such as TCP (Transmission Control Protocol), UDP (User Datagram Protocol) and DCCP (Datagram Congestion Control Protocol), and application layer protocols such as CoAP (Constrained Application Protocol) and FTP (File Transfer Protocol). It is to be understood and appreciated that these standards and protocols that can be utilized in the second communication network 118 may be used using either wired or wireless technology and in either LAN (local area network) and WAN (wide area network) environments.

In the given example of the third-party computer system 138 being configured as an electronic voting system that is enabled for packet data communication, an election administration and governing institution (which is commonly a constitutional commission) may have cooperation with a Telco or telecommunications company. The Telco may act as the issuer of the secure element 120 which is also preferably in the form of the aforementioned SIM card 120.

The voting application 134 may be arranged to be executable and operable from the SIM card 120 through the cooperation of the election administration and governing institution and the Telco. A voting user may initially present himself before the election administration and governing institution in order for him to submit to the same institution all the necessary valid proof of identification such as government issued identification cards and fill out all the necessary registration forms.

Along with the submission of the documentary requirements for voting, the electronic voting system, which is embodied by the third-party computer system 138 and is computer-implemented, may be used to capture and store the biometric information 106 of the voting user. The captured and stored biometric information 106 of the voting user may be processed by the electronic voting system 138 to generate and store in its server database unit 144 server-based reference biometric keys 146 associated with the voting user and which belongs to the plurality of sets of server-based reference biometric keys 146.

The set of server-based reference biometric keys 146 associated with the voting user is tagged by the electronic voting system 138 as corresponding to the registration information of the same voting user. The registration information of the voting user may include name information, address information, age information, gender information, and other demographic information that may be required by the election administration and governing institution.

A successful registration of the voting user with the election administration and governing institution permits him to use the voting application 134 arranged on the SIM card 120 and access third-party contents 136 residing on the electronic voting system 138 to cast his vote in an electronic manner at the time of election. From the convenience of home, office, mall, or just anywhere, the voting user may cause the execution of the voting application 134 residing on the SIM card 120 through the device user interface 112 of the information capturing and transaction device 102, which may be a smart-phone, that the voting user is using.

Access to the voting application 134 may require capturing, by an appropriate biometric sensor embodied by the biometric sensor 104 of the smart-phone 102, of the biometric information (e.g., a fingerprint information) 106 associated with the body feature (e.g., fingerprint) of the voting user.

The SIM card 120 is preferably arranged to receive the fingerprint information 106 from the smart-phone 102, process the fingerprint information 106 to derive SIM card-based captured biometric keys 132, and then permit access to the voting application 134 residing on the SIM card 120 based on a comparison of the SIM card-based captured biometric keys 132 with the SIM card-based reference biometric keys 126 associated with the voting user.

If the SIM card-based captured biometric keys 132 match with the SIM card-based reference biometric keys 126, then the voting user is provided with access to the voting application 134 residing on the SIM card 120 and in turn to the third-party contents 136 residing on the electronic voting system 138 interfaced with the voting application 134 residing on the SIM card 120. Otherwise, access to the voting application 134 residing on the SIM card 120 is denied or rejected thereby ensuring that no one else but the authorized voting user is permitted to use the voting application 134 and remotely access and/or manipulate the third-party contents 136 of the electronic voting system 138.

The voting application 134 may be arranged to provide a list of names of all candidates for various electoral posts (e.g., president, senator, congressman, and the like) for any given election event. These names form part of the third-party contents 136 that can be provided to and/or processed by the electronic voting system 138.

The provision of remote transmission of voting data between the smart-phone 102 and the electronic voting system 138 may be conducted over the second communication network 118 since the electronic voting system 138 is enabled for packet data communication. Once the user has selected the names of the candidates of his choosing, the SIM card 120 is arranged to communicate with the second communication network 118 in order to transmit the selected names (or the “voting data” or the “voting information”) to the electronic voting system 138.

An election authorization module is embodied by the authorization module 150 and resides on the electronic voting system 138. The election authorization module may be arranged suitable for use in authorizing a voting user account associated with the voting user to be used for performing an electronic voting transaction on the electronic voting system 138 based on a comparison of the secure element-based reference biometric keys 126 with the server-based reference biometric keys 146 pre-stored or pre-registered on the voting database system 144 residing on the electronic voting system 138.

The voting user account is permitted to effect the electronic voting transaction by way of the selection of the names of the candidates if and only if the secure element-based reference biometric keys 126 that the electronic voting system 138 receives from the smart-phone 102 match with any of the server-based reference biometric keys 146. A matching set of reference biometric keys 126, 146 means that the voting user account is authorized to perform the electronic voting transaction.

In one or more preferred implementations of the present invention, transaction related data such as the illustrated payment data and voting data may be temporarily or permanently stored on the SIM card 120 in an interactive and real-time manner. Since the memory unit 124 of the SIM card 120 may have limited storage capabilities, such transaction related data may be passed from the SIM card 120 to the device memory unit 110 of the mobile phone or smart-phone 102. In turn, the third-party contents 136 residing on the third-party computer system 138 may be updated in real-time or near real-time based on the transaction related data that the third-party computer system 138 receives from the mobile phone or smart-phone 102 over any of the first and second communication networks 116, 118 in an interactive and real-time manner.

It is to be understood and appreciated that the SIM card 120, by itself or in combination with the information capturing and transaction device 102 or such other electronic devices known in the relevant art, can have all the computing capabilities necessary to accomplish all the computing functions embodied by the system 100 for authorizing an electronic transaction of the present invention.

It is to be understood and appreciated that, although not fully described in the herein disclosure, the real-time or near real-time update between the third-party computer system 138 and the mobile phone or smart-phone 102 can be used to generate purchase history or purchase habit data, cross-reference data, and transaction behaviour pattern data, including audit trail, within a pre-determined time period. These data may further be used to provide targeted advertisements at the purchasing or voting user based on the same user's personal interests and relevant activities within any given period. Location-based data indicative of the geographical location of the mobile phone or smart-phone 102 may also be used to provide the targeted advertisements. These advertisements may be provided as in-app ads, e-mail campaigns, and pop-up ads on any of the plurality of applications 134.

It is also to be understood and appreciated that, although not fully described in the herein disclosure, the SIM card 120 may be immediately disabled by the issuer computer system of the Telco upon receiving request to do the same from the user. Disabling the SIM card 120 may render the plurality of applications 134 inoperative. Issuance of a new SIM card 120 may therefore be requested by the user at any point. Selective re-activation of the plurality of applications 134 may be performed by the user in a direct or remote manner. The SIM card 120 offers portability of access to services brought about by the applications 134 embedded on it, as it can be inserted from one information capturing and transaction device 102 to another.

The present invention may also provide a computer-implemented method for authorizing an electronic transaction. The method may include the steps of: (i) capturing, by the information capturing and transaction device 102, biometric information 106 from the human user; (ii) receiving, by the secure element 120, the captured biometric information 106 from the information capturing and transaction device 102; (iii) processing, by the secure element 120, the captured biometric information 106 to derive the set of secure element-based captured biometric keys 132; and (iv) permitting, by the secure element 120, the access to the application 134 residing on the secure element 120 based on the comparison of the set of secure element-based captured biometric keys 132 with the set of secure element-based reference biometric keys 126 depending on the configuration of the application.

The computer-implemented method of the present invention may also include the step of executing, by the secure element 120, the application to perform the electronic transaction on the third-party computer system 138 over any of the first communication network 116 operating in accordance with the first set of communication standards and protocols which enables the radio data communication and the second communication network 118 operating in accordance with the second set of communication standards and protocols which enables the packet data communication.

Further, the computer-implemented method of the present invention may include the step of executing the authorization module 150, by the third-party computer system 138, for authorizing the user account associated with the user to be used for performing the electronic transaction on the third-party computer system 138 based on the comparison of the set of secure element-based reference biometric keys 126 with each set of server-based reference biometric keys 146 of the plurality of sets of server-based reference biometric keys 146 and depending on the configuration of the third-party computer system 138.

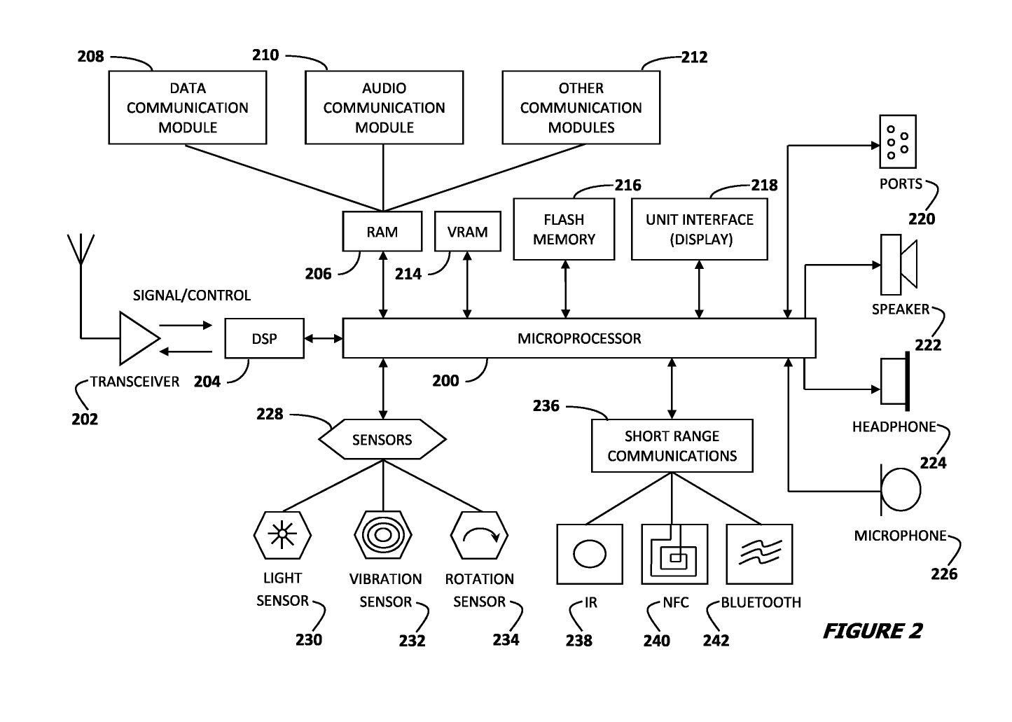

Referring to FIG. 2, there is shown a schematic block diagram illustrating an exemplary architecture of an information capturing and transaction device for use in the system of FIG. 1 and in accordance with one or more preferred implementations of the present invention. As illustrated, the hardware architecture of the information capturing and transaction device, which may be a mobile device, include core system resources such as a microprocessor 200, a transceiver 202, a DSP (digital signal processor) 204, a RAM (random access memory) 206 on and from which data communication module 208, audio communication module 210, and other communication modules 212 may be stored and executed, respectively, a VRAM (video random access memory) 214, a flash memory 216, and a unit interface (or display) 218.

As illustrated, the hardware architecture of the information capturing and transaction device may also include I/O subsystems such as ports 220, speaker 222, headphone 224, and microphone 226, sensor subsystems 228 such as light sensor 230, vibration sensor 232, and rotation sensor 234, and short-range communication subsystems 236 such as Infrared 238, NFC (near field communication) 240, and Bluetooth 242. These and other possible components of the information capturing and transaction device of the system illustrated in FIG. 1 may communicate with one another through one or more system buses.

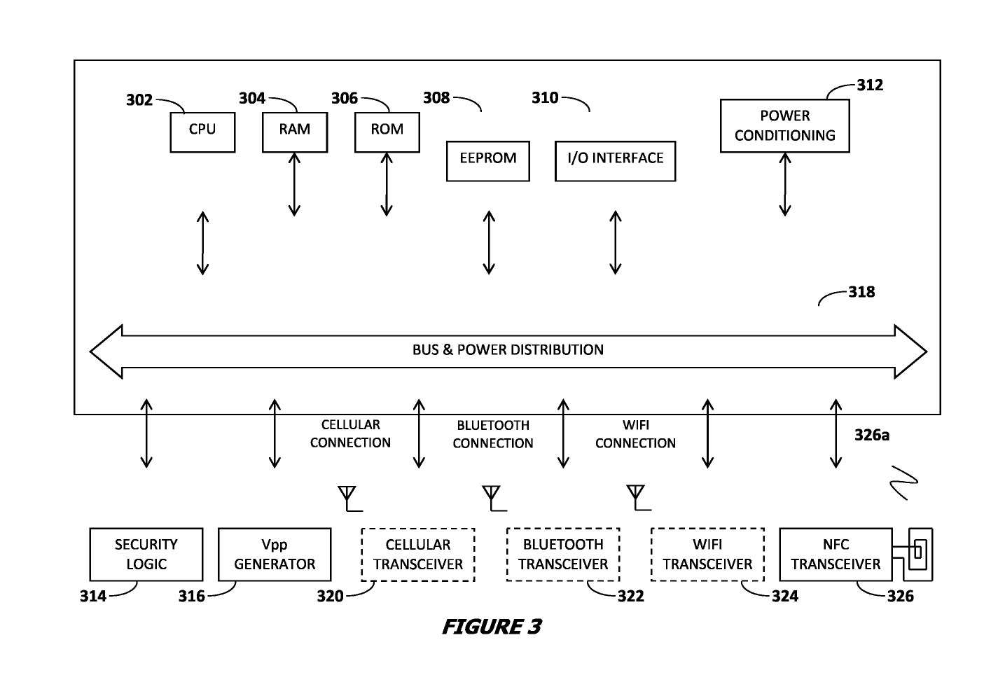

Referring to FIG. 3, there is shown a schematic block diagram illustrating an exemplary architecture of a secure element for use in the system of FIG. 1. The secure element, as described in greater detail in FIG. 1, may exist in the form of the aforementioned SIM card that can be inserted into the information capturing and transaction device of the system illustrated in FIG. 1.

The SIM card may include a SIM (subscriber identity module or subscriber identification module) that identifies the information capturing and transaction device into which it may be inserted. The SIM card may also include its own CPU (central processing unit) 302, a RAM (random access memory) 304, a ROM (read-only memory) 306, an EEPROM (electrically erasable programmable read-only memory) 308, and an input/output interface 310.

Like the usual design of SIM cards known in the relevant art, the SIM card of the present invention may also include a power conditioning element 312, a security logic 314, and a Vpp (peak-to-peak voltage) generator 316. These exemplary components of the SIM card may interact or communicate with one another through a bus and power distribution system 318. The SIM card may also include its own cellular transceiver 320, Bluetooth™ transceiver 322, Wi-Fi transceiver 324, and NFC transceiver 326 with antenna 326a. In this respect, the SIM card may also facilitate NFC-based communications dependently or independently of the information capturing and transaction device of the system illustrated in FIG. 1 and may receive incoming electronic transactions from other electronic devices or computer systems.

While the present invention has been described with respect to a limited number of implementations, those skilled in the art, having benefit of this disclosure, will appreciate that other implementations can be devised which do not depart from the scope of the present invention as disclosed herein.

1. A system for authorizing an electronic transaction, the system comprising:
an information capturing and transaction device capturing biometric information of a human user; and
a secure element in operative communication with the information capturing and transaction device and including
a secure element processing unit, and
a secure element memory unit in communication with the secure element processing unit and capable of storing at least one set of secure element-based reference biometric keys associated with the user,
wherein the secure element processing unit is configured to be capable of
receiving the captured biometric information from the information capturing and transaction device,
processing the captured biometric information to derive at least one set of secure element-based captured biometric keys, and
permitting an access to at least one application residing on the secure element based on a comparison of the set of secure element-based captured biometric keys with the set of secure element-based reference biometric keys depending on a configuration of the at least one application, and
wherein the at least one application can be used to perform at least one electronic transaction on a third-party computer system.

2. The system according claim 1, wherein the at least one application comprises a plurality of applications residing on the secure element.

3. The system according to claim 2, wherein the plurality of applications are selectively activatable.

4. The system according to claim 1, wherein the secure element includes a first circuitry operable to communicate with a first communication network operating in accordance with a first set of communication standards and protocols which enables radio data communication.

5. The system according to claim 1, wherein the secure element includes a second circuitry operable to communicate with a second communication network operating in accordance with a second set of communication standards and protocols which enables packet data communication.

6. The system according to claim 5, wherein the at least one application is executable and operable by the user through a device user interface of the information capturing and transaction device to access third-party contents residing on the third-party computer system via any of a first communication network and the second communication network depending on a configuration of the third-party computer system.

7. The system according claim 6, wherein the third-party computer system includes a server processing unit, a server memory unit, and a server database unit associated with the server processing unit and having pre-stored thereon a plurality of sets of server-based reference biometric keys.

8. The system according to claim 7, wherein the third-party computer system further includes an authorization module executable by the server processing unit from the server memory unit for authorizing at least one user account associated with the user to be used for performing the at least one electronic transaction on the third-party computer system based on a comparison of the set of secure element-based reference biometric keys with each set of server-based reference biometric keys of the plurality of sets of server-based reference biometric keys and depending on the configuration of the third-party computer system.

9. The system according to claim 1, wherein the secure element is any one of a Universal Integrated Circuit Card (UICC), an embedded Secure Element (eSE) card, a smart Secure Digital card, a smart micro Secure Digital card, and a SIM (subscriber identity module or subscriber identification module).
